(19) United States
(12) Patent Application Publication
(10) Pub. No.: US 2025/0257476 A1
(43) Pub. Date: Aug. 14, 2025

(54) SYSTEMS AND METHODS FOR INCREASED SULFURIC ACID CONCENTRATION FROM SULFUR DIOXIDE DEPOLARIZED ELECTROLYSIS AND USES THEREOF

(71) Applicant: Peregrine Hydrogen Inc., Santa Cruz, CA (US)

(72) Inventors: Matthew Shaner, Santa Cruz, CA (US); Stefan Omelchenko, Santa Cruz, CA (US)

(73) Assignee: Peregrine Hydrogen Inc., Santa Cruz, CA (US)

(21) Appl. No.: 19/052,739

(22) Filed: Feb. 13, 2025

Related U.S. Application Data
(60) Provisional application No. 63/552,974, filed on Feb. 13, 2024.
(60) Provisional application No. 63/562,120, filed on Mar. 6, 2024.
(60) Provisional application No. 63/572,562, filed on Apr. 1, 2024.

(51) Int. Cl. C25B 1/22; C01B 17/74; C01B 25/222; C01B 25/28; C01C 1/04; C22B 3/08; C25B 1/04; C25B 15/08

(52) U.S. Cl. CPC C25B 1/22; C01B 17/74; C01B 25/222; C01B 25/28; C01C 1/0405; C25B 1/04; C25B 15/081; C25B 15/087; C22B 3/08

(57) ABSTRACT

A method can include coupling sulfur dioxide depolarized electrolysis (e.g., electrochemical oxidation of sulfur dioxide to sulfuric acid with electrochemical reduction of water to hydrogen) with the contact process to facilitate formation of high concentration sulfuric acid with concurrent hydrogen production. The sulfuric acid and hydrogen can optionally be used cooperatively for downstream processes (e.g., metal extraction from ore, fertilizer production, hydrocarbon processing, etc.).

### CROSS-REFERENCE TO RELATED APPLICATIONS

This application claims the benefit of U.S. Provisional Application No. 63/552,974 filed 13 Feb. 2024, U.S. Provisional Application No. 63/562,120 filed 6 Mar. 2024, and U.S. Provisional Application No. 63/572,562 filed 1 Apr. 2024, each of which is incorporated in its entirety by this reference.

### TECHNICAL FIELD

This invention relates generally to the phosphoric acid production field, and more specifically to a new and useful system and method in the phosphoric acid production field.

### BRIEF DESCRIPTION OF THE FIGURES

FIG. 1 is a flow chart representation of an example of the process.

FIGS. 2A and 2B are chemical equations representing examples of the contact process from sulfur and oxygen to sulfuric acid production using different sulfuric acid starting concentrations in the second step. FIG. 2A shows an example of the second step using concentrated sulfuric acid (e.g., >95 wt %) and FIG. 2B shows an example of the second step using dilute sulfuric acid (e.g., <75 wt %).

FIG. 3 is a schematic representation of an example of a wet process for phosphoric acid production.

FIG. 4 is a schematic representation of an exemplary water balance in a phosphoric acid production process.

FIG. 5 is a graphical representation of exemplary equivalent water balancing for a phosphoric acid concentration as a function of wash ratio and sulfuric acid concentration. Each line represents an isosurface for a given water content of input phosphate material. The dashed line at about 2.8 wash ratio represents a wash ratio that produces at least a 90% absolute phosphorous recovery.

FIG. 6 is a schematic representation of an example of concentrating sulfuric acid formed using a sulfur depolarized electrolyzer and integrations with fertilizer production.

FIGS. 7-9 are flow chart representations of exemplary means for combining a sulfur dioxide depolarizer with the contact process (e.g., to generate higher concentrations of sulfuric acid than are generally achievable with SDE alone, to generate hydrogen concurrently with sulfuric acid which does not occur with the contact process alone, etc.).

FIG. 10 is a schematic representation of an example of integrating sulfur-dioxide depolarized electrolysis into a metal recovery operation from mining.

### DETAILED DESCRIPTION

The following description of the embodiments of the invention is not intended to limit the invention to these embodiments, but rather to enable any person skilled in the art to make and use this invention.

### 1. Overview

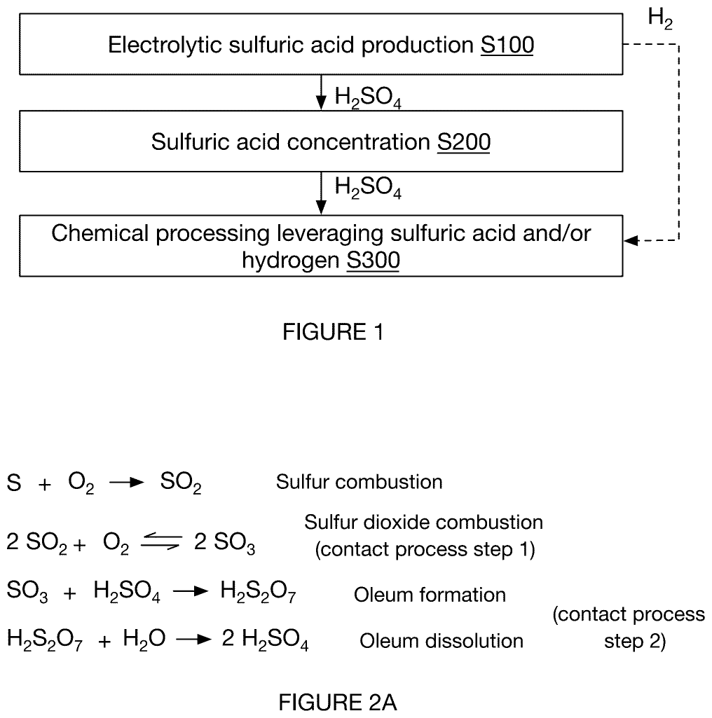

As shown in FIG. 1, a process can include: (electrolytically) generating sulfuric acid S100, concentrating the sulfuric acid S200, and optionally performing one or more chemical process using the sulfuric acid S300. As shown in FIG. 1, S100 can additionally produce hydrogen (H₂) which can additionally or alternatively be used in S300. In one example, S300 can include producing phosphoric acid using sulfuric acid S400 and producing fertilizer S500 (e.g., by combining phosphoric acid with ammonia). In another example, S300 can include leaching one or more metal ions from a metal ore and optionally reducing the metal ions (e.g., using the hydrogen). However, S300 can include other suitable chemical, physical, and/or other suitable processes leveraging sulfuric acid and/or hydrogen.

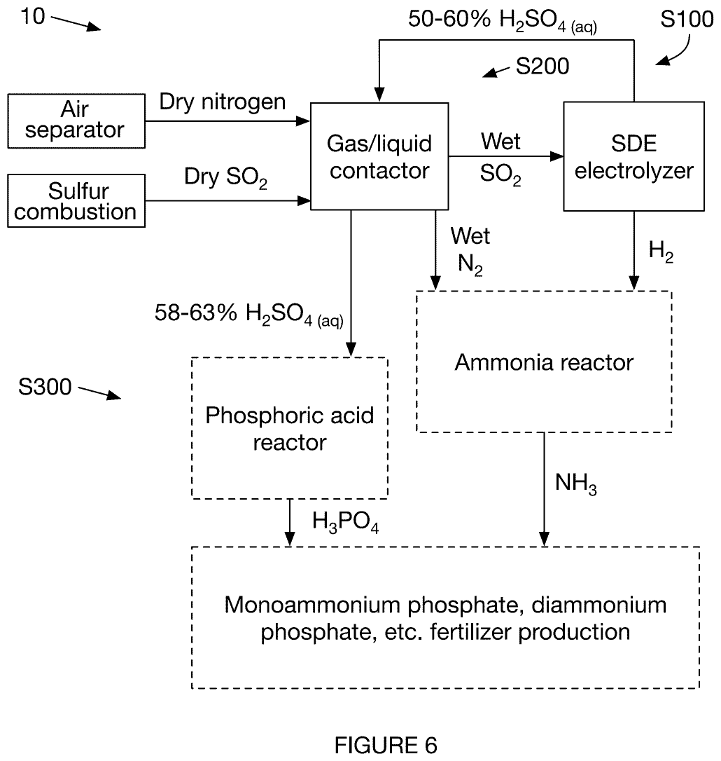

In a specific example of the process, sulfuric acid can be produced using a sulfur dioxide depolarized electrolyzer (e.g., contemporaneously with producing H₂) at a concentration of at most approximately 50 wt % sulfuric acid, sulfur trioxide can be received (e.g., via a first step of a contact process where sulfur dioxide is combusted to for sulfur trioxide; via combustion of a sulfur precursor to sulfur trioxide; via combustion of a sulfide ore, mineral, compound, etc.; etc.), the 50 wt % sulfuric acid can be reacted with the sulfur trioxide to concentrate the sulfuric acid (e.g., via a second step of the contact process) to result in about 70 wt % sulfuric acid (assuming approximately 1:1 by moles sulfuric acid to sulfur trioxide where other concentrations can be achieved using other molar ratios of sulfuric acid to sulfur trioxide). In variations of this illustrative example, the concentrated sulfuric acid (e.g., without further concentration) can be reacted with phosphate ore to produce phosphoric acid, the H₂ can be reacted with nitrogen (N₂) to form ammonia (e.g., via the Haber-Bosch process), and the ammonia can be reacted with the phosphoric acid to produce ammonium phosphate fertilizer(s) (e.g., diammonium phosphate, monoammonium phosphate). In a variation of this specific example (as shown for instance in FIG. 6), the sulfuric acid can be concentrated by first passing dry gas (e.g., a gas with relative humidity less than 20% such as dry sulfur dioxide, dry nitrogen, etc.) over or through the wet sulfuric acid. In this variation, the 50 wt % sulfuric acid can be concentrated to about 60 wt % sulfuric acid, where the about 60 wt % sulfuric acid can then be used in the second step of the contact process (e.g., resulting in approximately 80 wt % sulfuric acid when approximately 1:1 by moles sulfuric acid to sulfur trioxide are reacted). Other concentrations can be achieved (e.g., based on how dry the gas is, the temperature of the mixture, etc.) before or after further concentration. In other variations of this specific example (that can be combined with the preceding variation to result in further concentration enhancements), an advanced SDE electrolyzer (such as an electrolyzer as described in U.S. Provisional Application 63/568,944 titled ‘SULFUR DIOXIDE ELECTROLYZER WITH IMPROVED SULFURIC ACID CONCENTRATION FORMATION AND METHOD OF OPERATION’ filed 22 Mar. 2024 or patent applications claiming priority thereto, which are incorporated in their entirety by this reference) can be used that results in >50 wt % (e.g., 55%, 60%, 65%, 70%, 75%, etc.) sulfuric acid as the electrolyzer output.

### 2. Technical Advantages

Variants of the technology can confer one or more advantages over conventional technologies.

First, the inventors have discovered that a sulfur depolarized electrolyzer can enable multiple integrations into a single application. For instance, a sulfur depolarized electrolyzer can generate (e.g., coproduce) sulfuric acid with hydrogen. Some applications (e.g., chemical manufacturing, pharmaceutical manufacturing, fertilizer production, mining, metal recovery from ores such as nickel laterite, etc.) are more efficient when performed using and/or require both sulfuric acid and hydrogen, thus coproduction of sulfuric acid and hydrogen can be highly valuable. Moreover, some variants of the depolarizer electrolyzer can further leverage the integration between processing steps performed at a shared location by using heat, electricity, pressure, and/or other nonchemical outputs generated during processes in subsequent processes. Relatedly, the coproduction can also be beneficial for enabling recycling of chemical species (e.g., byproducts, unreacted species, etc.) thereby enhancing an efficiency of the process (e.g., total conversion efficiency from SO₂ to H₂SO₄, single pass conversion efficiency, etc.) or reducing a carbon footprint of the overall process compared with existing technological solutions.

Second, the inventors have found that despite conventional wisdom in the field suggesting that concentrated (e.g., >95 wt %) sulfuric acid is necessary for high phosphorous recovery, lower concentrations of sulfuric acid can be used without increasing an environmental impact of the process (e.g., without requiring additional concentration of phosphoric acid compared to traditional results). For example, by adjusting the water balance between different water sources in phosphoric acid production (e.g., the sulfuric acid, phosphate ore, and wash water), little loss of phosphorous can occur.

Third, variants of the technology can utilize lower concentration sulfuric acid to produce phosphoric acid as compared to existing solutions, without significantly impacting a concentration and/or phosphorous recovery. For instance, <90 wt % (e.g., 50%, 60%, 70%, 75%, 80%, etc.) sulfuric acid can be used to extract phosphoric acid from phosphate ore with greater than 90% (e.g., 91%, 92%, 93%, 94%, 95%, 97%, 97.5%, 98%, 99%, 99.5%, etc.) phosphorous recovery and P₂O₅ concentration of 23-33% (e.g., prior to further concentration steps). Similarly, lower concentrations of sulfuric acid can be used for metal extractions and/or other processes leveraging sulfuric acid (and optionally hydrogen in a cooperative manner).

Fourth, variants of the technology can enable tuning of a sulfuric acid concentration (typically concomitantly with amount of hydrogen produced) using sulfur dioxide depolarized electrolysis. In one example, SDE can be combined with the contact process (or other sulfuric acid production processes) to increase a sulfuric acid concentration. While the final concentration can be tuned across the range of sulfuric acid concentrations between the SDE sulfuric acid output and the contact process sulfuric acid output, as one illustrative example sulfuric acid from SDE (about 50 wt %) can be concentrated to about 70 wt % using a 1:1 ratio of sulfuric acid from SDE to contact process.

However, further advantages can be provided by the system and method disclosed herein.

### 3. Method

As shown in FIG. 1, a process can include: (electrolytically) generating sulfuric acid S100, concentrating the sulfuric acid S200, and optionally performing one or more chemical process using the sulfuric acid S300. As shown in FIG. 1, S100 can additionally produce hydrogen (H₂) which can additionally or alternatively be used in S300. In one example, S300 can include producing phosphoric acid using sulfuric acid S400 and producing fertilizer S500 (e.g., by combining phosphoric acid with ammonia). In another example, S300 can include leaching one or more metal ions from a metal ore and optionally reducing the metal ions (e.g., using the hydrogen). However, S300 can include other suitable chemical, physical, and/or other suitable processes leveraging sulfuric acid and/or hydrogen.

The method can be performed continuously and/or in batches (e.g., intermittently such as only when green electricity is available). All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed. The method (e.g., each step thereof) is preferably performed at a shared facility and/or location (e.g., to minimize storage, handling, transportation, etc.). However, different steps can be performed at different locations.

In a specific example, the method can be performed using a combination of one or more furnaces (e.g., operable to heat one or more substances to a temperature between about 100-1500° C. or any temperature or temperature range contained therein in air, in an oxidizing environment such as an oxygen enriched atmosphere, in a reducing environment, etc.), electrolyzers (e.g., an electrolyzer as described in U.S. patent application Ser. No. 18/376,312 titled ‘SULFUR DIOXIDE DEPOLARIZED ELECTROLYSIS AND ELECTROLYZER THEREFORE’ filed 3 Oct. 2023 which is incorporated in its entirety by this reference), and/or reaction vessels (e.g., bomb calorimeter, pressure container, pressurized furnace, phosphoric acid reactor, etc.). However, the method can be performed using any suitable equipment and/or reaction vessels.

Generating sulfuric acid S100 functions to oxidize sulfur dioxide to sulfuric acid (e.g., contemporaneously with reducing water to hydrogen). S100 is preferably performed using an electrolyzer. However, S100 can be performed using any suitable component(s).

Typically, S100 requires input energy (e.g., electricity, heat, etc.) to operate. As an illustrative example, when sulfur dioxide oxidation to sulfuric acid is coupled with water hydrolysis to hydrogen, an electrical potential of at least 0.17V can be required (and often an overpotential on the order of hundreds of mV such as 100 mV, 200 mV, 300 mV, 500 mV, 700 mV, etc. is applied).

A current density during S100 is preferably at least about 1 A/cm² (e.g., 0.95 A/cm², 1.1 A/cm², 1.2 A/cm², 1.5 A/cm², 2 A/cm², etc.). However, any suitable current density can be used.

The sulfur dioxide oxidation is preferably performed at elevated temperatures (e.g., temperatures above room temperature such as 50° C., 60° C., 70° C., 80° C., 90° C., 100° C., 120° C., 150° C., 180° C., 200° C., 225° C., 250° C., 300° C., 350° C., 374° C., values or ranges therebetween, etc.). However, the sulfur dioxide oxidation can be performed at or below room temperature (e.g., using a greater overpotential).

S100 is preferably performed without recycling sulfuric acid into sulfur dioxide (i.e., sulfuric acid is not use catalytically, S100 is performed as a feedthrough process, etc.). However, sulfuric acid can be reduced to sulfur dioxide (e.g., for catalytic or cyclic performance of S100; for instance when excess sulfuric acid is generated relative to hydrogen, to maintain a target sulfur dioxide concentration or pressure, when insufficient sulfur dioxide is received, etc.). In an illustrative example, less than about 5% of sulfuric acid generated in S100 can be reduced to sulfur dioxide and reintroduced into the electrolyzer (via the anolyte inlet).

The sulfur dioxide used in S100 can be generated by combustion of (e.g., roasting) sulfur precursors. Exemplary sulfur precursors include (but are not limited to): sulfur (e.g., disulfur, trisulfur, tetrasulfur, cyclo-(penta; hexa; octa; nona; deca; undeca; dodeca; trideca; tetradeca; pentadeca; octadeca; eicosa; etc.)sulfur, fibrous sulfur, lamina sulfur, amorphous sulfur, insoluble sulfur, φ-sulfur, ω-sulfur, λ-sulfur, μ-sulfur, π-sulfur, etc.), hydrogen sulfide (e.g., H₂S; pure hydrogen sulfide; impurity hydrogen sulfide in other materials such as sour gas, sour petroleum, sour crude oil, etc.; etc.), sulfur ores (e.g., acanthite Ag₂S, chalcocite Cu₂S, bornite Cu₅FeS₄, galena PbS, sphalerite ZnS, chalcopyrite CuFeS₂, pyrrhotite Fe₁₋ₓS, millerite NiS, pentlandite (Fe,Ni)₉S₈, covellite CuS, cinnabar HgS, realgar AsS, orpiment As₂S₃, stibnite Sb₂S₃, pyrite FeS₂, marcasite FeS₂, molybenite MoS₂, cobaltite (Co,Fe)AsS, arsenopyrite FeAsS, Gerdorffite NiAsS, pyrargyrite Ag₃SbS₃, proustite Ag₃AsS₃, tetrahedrite Cu₁₂Sb₄S₁₃, tennantite Cu₁₂As₄S₁₃, enargite Cu₃AsS₄, bournonite PbCuSbS₃, jamesonite Pb₄FeSb₆S₁₄, cylindrite Pb₃Sn₄FeSb₂S₁₄, etc.), metal sulfides (e.g., transition metal sulfides, alkali metal sulfides, post-transition metal sulfides, etc.), and/or any suitable precursor(s) can be used. The sulfur precursors can be roasted in air, in an oxygen-enriched air (e.g., formed using an air separator), in concentrated oxygen (e.g., oxycombustion), and/or in any suitable oxidizing environment.

In some variants, heat generated by roasting the sulfur precursor(s) can be leveraged by other steps in the process (e.g., concentrating the phosphoric acid, providing heat for the Haber-Bosch process, heating the electrolyzer, concentrating the sulfuric acid, etc.).

In variants of S100 that include air separation (e.g., to form oxygen-enriched environments, to separate oxygen from nitrogen, etc.), the resulting nitrogen (and/or deoxygenated air but referred to as nitrogen for simplicity) can optionally be used in downstream processes. For instance (as shown for example in FIG. 6), when the resulting nitrogen is dry (e.g., relative humidity less than 0%, 10%, 20%, 30%, 40%, 50%, values or ranges therebetween, etc.), the nitrogen can be passed over and/or through the sulfuric acid produced in S100 (e.g., in a gas-liquid contactor). Bypassing the dry nitrogen over and/or through the sulfuric acid, the sulfuric acid concentration can be increased (e.g., water can be removed from the sulfuric acid). The extent of concentration in these variants can depend on the relative humidity of the nitrogen, the concentration of sulfuric acid, the duration of contact, the volume of nitrogen, the volume of sulfuric acid solution, and/or can depend on any suitable properties. As a specific example, 50 wt % sulfuric acid with dry (e.g., approximately 0% RH) nitrogen can be concentrated to about 58 wt % sulfuric acid in this manner. Similarly, 60 wt % sulfuric acid can be concentrated to about 63 wt % sulfuric acid in this manner. In another variant, the separated nitrogen can be used in a downstream ammonia production process. However, the nitrogen can otherwise be discarded and/or used.

In related variants, the sulfur dioxide (e.g., prior to oxidation) can be used to concentrate the sulfuric acid (particularly, but not exclusively when the sulfur dioxide is dry such as RH 0%, ≤10%, ≤20%, ≤30%, ≤40%, ≤≤50%, etc.). These variants can also be beneficial as the sulfur dioxide stream can optionally include water (e.g., water that is to be reduced at the cathode) and thus can add moisture to the sulfur dioxide while removing moisture from the sulfuric acid. Additionally and/or alternatively, water can be independently introduced into the sulfur dioxide, dry sulfur dioxide (as a gas and/or liquid) can be injected into the electrolyzer (e.g., where water for the reduction reaction can be introduced exclusively on the cathode side of the electrolyzer), and/or other combinations thereof can be used.

After S100, the sulfuric acid concentration is typically at most about 60% (e.g., wt %, vol %, mol %, etc. such as 63%, 58%, 50%, 45%, 40%, etc.).

Concentrating the sulfuric acid S200 functions to increase a concentration of the sulfuric acid solution from S100. S200 preferably increases the concentration of the sulfuric acid without requiring a significant net usage of energy (e.g., without requiring additional heat to concentrate the sulfuric acid by evaporating water). For instance, S200 can generate additional heat (and/or electricity or other forms of energy) that can be used in upstream and/or downstream processes.

After S200, the concentration of sulfuric acid is preferably greater than about 65% (wt %, vol %, mol %, etc. such as 70%, 71%, 72%, 75%, 80%, 80.5%, 81%, 83%, 90%, etc.). However, the exact concentration can depend on the starting sulfuric acid concentration. In different variants, S200 can result in an absolute increase in sulfuric acid concentration by about 17.5% and 25% (corresponding to a relative increase from the starting concentration of between about 20% and 50%). However, S200 can result in any suitable increase in sulfuric acid concentration.

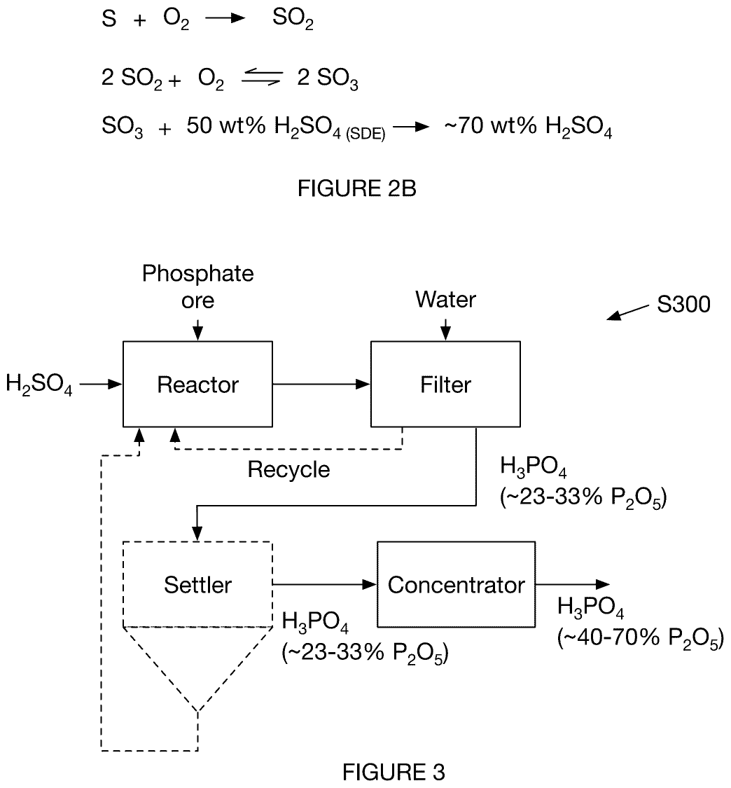

S200 can concentrate the sulfuric acid by: passing dry gas over or through the sulfuric acid (e.g., as described in S100, using additional or alternative dry gases formed as a result of other upstream or downstream coupled processes, etc.), by combining sulfur trioxide (e.g., from a first step of the contact process) with the sulfuric acid from S100 and performing the second step of the contact process (e.g., as shown for example in FIG. 2A or FIG. 2B), by mixing the sulfuric acid with sulfuric acid produced using a second process (e.g., contact process, wet sulfuric acid process, metabifulfite method, burning sulfur with saltpeter, electrolysis of copper sulfate potentially utilizing the same electrolyzer as in S100, electrobromine method, lead chamber process, dissolving sulfur dioxide in an aqueous solution of an oxidizing metal salt such as iron(III) or copper (II), etc.), desiccating the sulfuric acid solution (e.g., dehydrating, such as using solar energy, gypsum or selenite from the phosphoric acid production in S400 to anhydrite or bassanite and passing the sulfuric acid over anhydrite, anhydrous calcium sulfate, or bassanite, calcium sulfate hemihydrate, to desiccate the sulfuric acid), and/or other suitable processes.

In variants of S200 that include performing the contact process, S200 can include generating sulfur trioxide S250. The sulfur trioxide in S250 is preferably generated by performing the first portion of the contact process (e.g., as shown for example in FIG. 2A or FIG. 2B, oxidizing sulfur dioxide in the presence of oxygen and a catalyst such as a vanadium(V) oxide catalyst, where the sulfur dioxide can be generated from a sulfur precursor oxidation such as in S100, from reduction of a sulfate material such as calcium sulfate, sulfuric acid, etc.). However, the sulfur trioxide can additionally or alternatively be generated using salt pyrolysis (e.g., sodium bisulfate dehydration and cracking, tin chloride hydrolysis, etc.), by dehydrating sulfuric acid (e.g., using phosphorous pentoxide), and/or in any suitable manner.

In variants of S200 that include combining the sulfuric acid with sulfur trioxide (e.g., performing the second step of the contact process using the output sulfuric acid from the electrolysis process in S100, as shown for example in FIG. 8), the sulfuric acid from S100 is preferably combined with sulfur trioxide (e.g., from S250) in at most a 1:1 ratio (by total mass, by mass of sulfur, by moles of sulfur, by moles of reagent, by volume, etc.). Ratios that include additional sulfur trioxide can result in higher concentrations sulfuric acid; however, the balance with the production of hydrogen (from S100) is generally less than desired and therefore ratios favoring additional sulfuric acid relative to sulfur trioxide are preferred. As an illustrative example, a preferred overall stoichiometric ratio between hydrogen and sulfuric acid is about 0.5 to 1.5; noting that a 1:1 addition of sulfur trioxide to sulfuric acid results in a ratio of about 0.5. However, the stoichiometric ratio of hydrogen to sulfuric acid can otherwise be tuned (e.g., via concurrent water electrolysis, supplementation with methane reforming, etc.) and/or other stoichiometric ratios can be favored (e.g., depending on an application in 300). As a concrete example, when 50% sulfuric acid is used to perform the second step of the contact process with an equi-mole content of sulfur trioxide, the resulting sulfuric acid concentration can be about 71% (wt %, vol %, mol %, etc.). In some examples, these variants can result in higher concentrations of sulfuric acid than would be estimated from simple molar sulfur balancing (e.g., because of high heat of dissolution resulting in water evaporation, because of water uptake with the SO₃ to form the H₂SO₄, etc.).

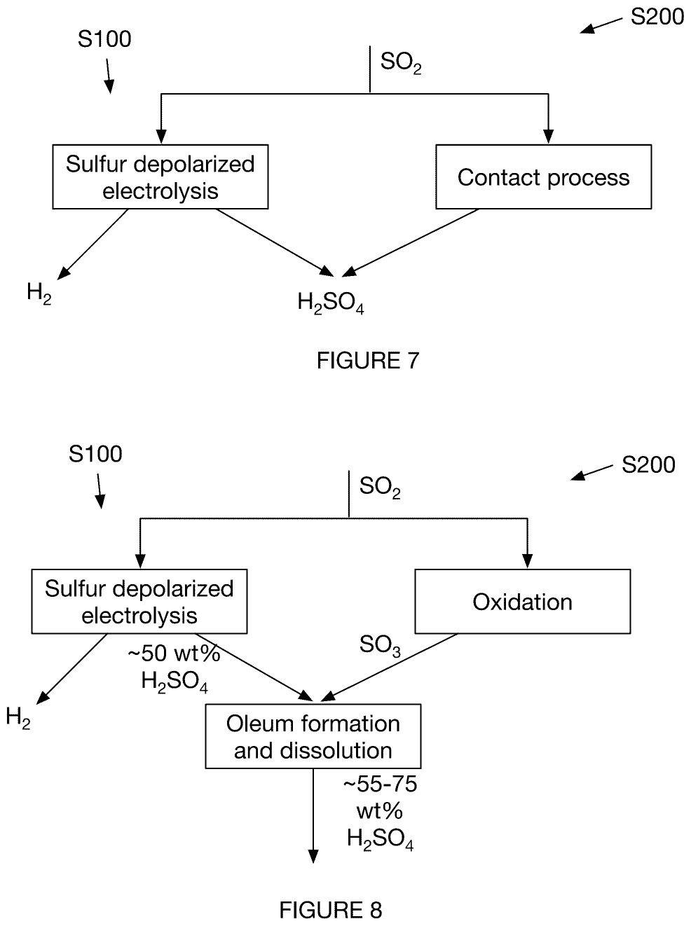

In another variant of S200, sulfuric acid (e.g., produced from the contact process) can be combined with sulfuric acid produced from S100 (as shown for example in FIG. 7). For instance, equimolar flow rates of sulfur for each process can be used. As a concrete example, when sulfuric acid from S100 (e.g., 50-60% sulfuric acid) is concentrated by combining with sulfuric acid from the contact process (e.g., >98% sulfuric acid) in equimolar concentrations, the resulting sulfuric acid can have a concentration of about 71% (wt %, vol %, mol %, etc.). However, the sulfuric acid from S100 and other sources can be combined in nonequimolar concentrations (e.g., of sulfur atoms) to result in other concentrations between the less concentrated and more concentrated sources (and/or to result in other byproducts in suitable ratios such as heat, pressure, etc.).

In some variants, the sulfuric acid can be concentrated (additionally or alternatively to integrations with the contact process) via evaporation (e.g., evaporating solvent such as water while retaining the species such as sulfuric acid), distillation, filtration and/or sorption (e.g., using a gypsum filter to separate water and sulfuric acid, using a desiccant to remove water from sulfuric acid, etc.), and/or in any suitable manner. In a specific example, the concentration of sulfuric acid generated in S100 can be increased from between 20-50% up to 30 to 95% (e.g., % w/w, % v/v, % w/v, % v/w, etc.) by evaporating water from the sulfuric acid solution (where the resulting concentrated sulfuric acid can then be integrated with the contact process, where concentrated sulfuric acid from after combining S100 and S200 can be further concentrated, etc.). In variations of this example, heat from the combustion of sulfur (e.g., in S100) and/or heat of dilution from dissolving the SO₃ in the sulfuric acid (e.g., in S200) can be leveraged for the water evaporation (e.g., without requiring additional energy input for sources outside of the method).

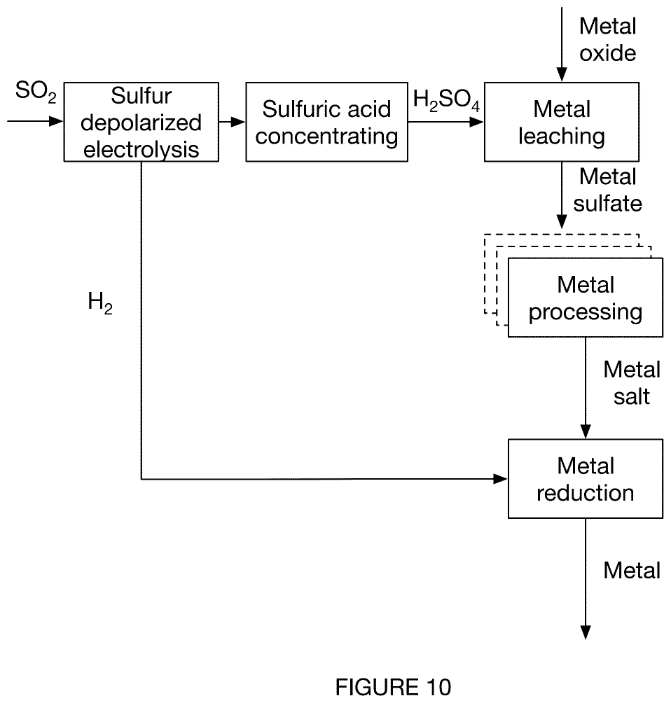

Performing one or more chemical process S300 using the sulfuric acid can function to use sulfuric acid (and/or other oxidized anolyte) and/or hydrogen (and/or other reduced catholyte) from S100 and/or S200. S300 can include the same and/or different processes from those performed on precursors as in S100. The sulfuric acid and hydrogen preferably cooperatively interact within the processing (e.g., the sulfuric acid and hydrogen are preferably both used in the processing step such as within the same reaction, to produce two products that are then reacted together, enhance a reaction rate for each other, as shown for example in FIG. 6 or FIG. 10, etc.). However, the sulfuric acid and hydrogen can be used in separated processing steps (e.g., where products from the processing steps are not necessarily combined in further processes).

Variants of S300 can include: purifying one or more species S310, reducing one or more species S330, oxidizing one or more species S340, dissolving one or more species S350, complexing one or more species S360, and/or any suitable steps.

Purifying one or more species S310 can function to decrease an impurity concentration within the sulfuric acid and/or hydrogen from S200 and/or S100. Examples of impurities that can be removed from sulfuric acid can include unoxidized sulfur dioxide (which can then be utilized in S100 and/or S200), carrier gas (e.g., air, nitrogen, oxygen, argon, etc.), and/or other impurities or other species that may be desirable to remove (e.g., nitric acid, water, nitrogen oxides, carbon dioxide, carbon monoxide, etc.) can be removed from the sulfuric acid. Examples of impurities that can be removed from hydrogen include water, hydrogen sulfide, and/or other impurities. The impurities can be removed using adsorption, absorption, phase changes (e.g., converting the impurities into a different phase from the material to be purified and physically separating the impurities and the material to be captured), using differential solubilities in different solvent systems, distillation, and/or in any suitable manner. For instance, a stripper can be used to remove SO₂ from H₂SO₄.

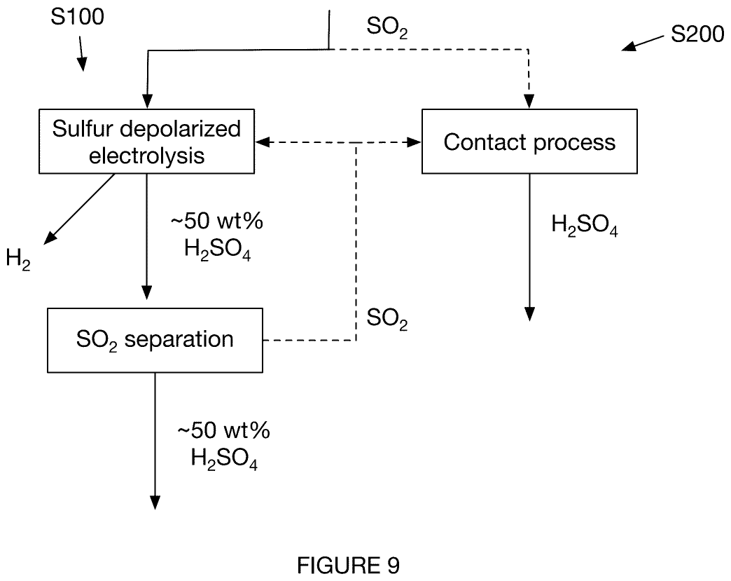

The recovered impurities are preferably reused (e.g., recycled) in the method. As a first example (as shown for example in FIG. 9), unoxidized sulfur dioxide can be fed back into the electrolyzer (e.g., in S100) and/or can be used in the contact process (e.g., S200). In the first illustrative example, the amount of recycled sulfur dioxide sent to each process can be determined based on one or more of a target sulfuric acid concentration, a target hydrogen to sulfur ratio, a target heat generation, and/or other suitable property or parameter. As non-limiting examples, 100% of recycled SO₂ can be provided to the electrolyzer to produce additional hydrogen; 100% of recycled SO₂ can be provided to the contact process to produce higher quantities of and/or concentrations of sulfuric acid and/or to produce additional heat (e.g., via combustion, via heat of dissolution, via heat of dilution, etc.); and/or other intermediate amounts of recycled SO₂ can be provided to the electrolyzer and contact process contemporaneously to balance the ratio of hydrogen to sulfur output. As a second example, hydrogen sulfide can be introduced into a furnace to undergo combustion or oxycombustion (e.g., in S100). As a third example, recovered carrier gases can be reused as carrier gas and/or can be used to extract water (e.g., to concentrate the sulfuric acid from S100 and/or S200). However, the recovered impurities do not have to be reused (e.g., can be disposed of, can be used for other processes, etc.).

Reducing one or more species S330 preferably functions to reduce a species using hydrogen (e.g., from S200, from S310, from S320, etc.). Examples of species to be reduced include metal oxides (e.g., nickel laterite, nickel oxide, iron oxide, copper oxide, uranium oxide, lithium oxide, sodium oxide, etc.), nitrogen, and/or any suitable species can be reduced. For instance, nitrogen gas (e.g., nitrogen concentrated gas from S100) can be reduced using hydrogen via a Haber Bosch process (or other process such described as below) to generate ammonia. Similarly, metal oxides (or other metal salts, metal minerals, etc.) can be reduced using hydrogen. However, the species can be reduced in any suitable manner.

In variations of S330, heat from the combustion of sulfur precursors (e.g., in S100, combustion of sulfur with oxygen) can be leveraged for the reduction reaction (e.g., without requiring additional energy input for sources outside of the method).

Oxidizing one or more species S340 can function to oxidize a species using sulfuric acid (e.g., from S100, from S200, etc.). For instance, metals (such as copper) can be oxidized using sulfuric acid. Note that sulfur dioxide that is generated during the oxidation process can be recycled into the electrolyzer (e.g., in S100) to form further sulfuric acid. Heat generated in S340 can be used in any manner as discussed for heat used from S100 processes (e.g., to facilitate reactions or processes within the method and minimizing an amount of external input energy required).

Dissolving one or more species S350 functions to increase a solubility of species (e.g., metal ions) and/or suspend species in solution. Basic species (e.g., lewis bases, Brønsted bases, etc.) are typically dissolved using sulfuric acid, while acidic species (e.g., Lewis acids, Brønsted acids, etc.) can be dissolved using hydrogen. Dissolving one or more species can includes performing a double substitution reaction, a single substitution reaction, and/or any suitable reaction. For example, metal oxides (e.g., nickel laterite, nickel oxide, etc.), metal phosphates (e.g., phosphate ores such as magnesium phosphate, calcium phosphate, etc.), and/or other suitable species can be dissolved using sulfuric acid. In this example, the metal cations can be dissolved in the solution, can form metal sulfates (which may dissolve in water or other solvent and/or can precipitate from solution), and/or can otherwise be formed (e.g., concomitantly with the formation of water). In variations of this example that use phosphates, phosphoric acid (and/or phosphate salts related thereto) can be formed. However, any suitable species can be formed during dissolution of the one or more species.

In some variations, sulfur species (e.g., elemental sulfur, hydrogen sulfide, a sulfur precursor in S100, etc.) can be used to separate dissolved metals (e.g., based on differential solubility of metal sulfides). The resulting metal sulfides can then be combusted and/or oxycombusted (e.g., in S100) to generate sulfur dioxide (with the advantage of also facilitating the separation of one or more valuable metals such as nickel from other impurity metals such as iron).

Complexing one or more species S360 can function to generate a complex that can be used for separation, for applications (e.g., as a fertilizer), for storage, for transportation, and/or can otherwise be used. The species used to form the complex are typically derived from (directly or indirectly) or directly include the hydrogen and the sulfuric acid (e.g., from S100, S200, etc.). However, the species can be derived from any suitable source(s).

In some variants, S300 can include producing phosphoric acid using sulfuric acid S400, producing fertilizer S500, extracting and/or separating metals from ore S600, sulfuric acid regeneration (e.g., to improve a purity or concentration of spent sulfuric acid from refineries, chemical manufacturing plants, etc.), and/or other suitable processes.

Producing phosphoric acid using sulfuric acid S400 functions to generate phosphoric acid by reacting sulfuric acid with phosphate ore (particularly apatite such as calcium hydroxyapatite, calcium fluoroapatite, and/or calcium chloroapatite). The phosphoric acid is preferably produced with a phosphorous recovery of at least about 90% (e.g., at least 90% of phosphorous atoms from the phosphorous-containing ore are collected in the phosphoric acid) such as 91%, 92%, 94%, 95%, 97.5%, 98%, 99%, 99.5%, and/or other suitable values. The phosphoric acid is preferably produced at a concentration of about 28% (e.g., wt %, mol %, vol %, etc.) on a P₂O₅ basis. For instance, the concentration of the phosphoric acid can be 23-33%. However, the phosphoric acid can have any suitable recovery and/or any suitable concentration. S400 generally leverages a wet phosphoric acid process. However, a dry process can additionally or alternatively be used (particularly when the process is connected to a cement process such as that disclosed in U.S. patent application Ser. No. 18/527,042 titled ‘SYSTEM AND METHOD FOR PRODUCTION OF CALCIUM OXIDE WITH REDUCED CARBON FOOTPRINT’ filed 1 Dec. 2023 which is incorporated in its entirety by this reference as the dry phosphoric process can produce calcium silicate) and/or any suitable process can be used.

S400 can include (as shown for example in FIG. 3): digesting a phosphate material with sulfuric acid S420 (e.g., an acid digestion stage), washing the remaining solids S440 (e.g., a wash stage), purifying the phosphoric acid and/or remaining solids S460 (e.g., a purification stage), concentrating the phosphoric acid S480 (e.g., a concentration stage), and/or any suitable processes and/or steps.

Digesting a phosphate material S420 with sulfuric acid functions to convert phosphate materials to sulfate materials and phosphoric acid (or related species). Exemplary phosphate materials (phosphate ore, phosphate rock, phosphate mineral, etc.) include: apatite (e.g., hydroxylapatite, fluoroapatite, chlorapatite, bromapatite, etc.), triphylite, monazite, hinsdalite, pyromorphite, erythrite, amblygonite, lazulite, wavellite, turquoise, autunite, phosphophyllite, struvite, xenotime, mitridatite, allanpringite, beraunite, brazilanite, eosphorite, lithiophilite, metatorbernite, monazite, taranakite, variscite, wavellite, turquoise, whitlockite, santabarbaraite, scorodite, and/or other suitable phosphate materials. While the phosphate materials are often mined and/or shipped as slurries (e.g., having a water content of greater than about 30% by mass), the phosphate material is preferably digested as either dry rock (e.g., having a water content less than about 5%) or damp rock (e.g., having a water content between about 5 and 20% by mass). The slurry is preferably dried using low energy processes (e.g., air drying, filtering, forced air drying, solar drying, drainage, etc.). However, additionally or alternatively more energy intensive processes can be used in some variants (e.g., centrifugation, desiccation, heating, dehydration, etc. such as when a processing facility has additional energy available).

The phosphate material is preferably digested using the sulfuric acid from S200 (e.g., concentrated sulfuric acid). However, additionally or alternatively the phosphate material can be digested using sulfuric acid from S100 (e.g., comparatively dilute sulfuric acid) and/or from other suitable source(s).

Washing the remaining solids S440 (e.g., a wash stage) functions to improve a recovery of phosphorous from the remaining solids (e.g., calcium sulfate when apatite is used as a phosphorous material, where the calcium sulfate is preferably gypsum i.e., calcium sulfate dihydrate, but could be selenite, bassanite, anhydrite, or other suitable calcium sulfates or other materials). The solids are typically washed with water a plurality of times (e.g., 2×, 3×, 5×, etc.) to optimize recovery of phosphorous (where wash water can be reused for different wash steps). To achieve a target phosphoric acid concentration and/or phosphoric acid concentration, the process water wash ratio (e.g., mass of water/mass of P₂O₅) is preferably 2.8 or lower (e.g., 2.72, 2.7, 2.63, 2.6, 2.57, 2.5, 2.45, 2.44, 2.4, etc.). In contrast, traditional phosphoric acid production utilizes process water wash ratio greater than 2.8 (e.g., 4.4, 5). However, variants of the technology can operate with a lower process water wash ratio (e.g., with a reduced concentration of phosphoric acid).

In some variants, sulfuric acid can be included in the wash water. In these variants, the sulfuric acid in the wash can function to digest unreacted phosphate material in the remaining solids, thereby increasing a yield of phosphorous (and thereby enabling greater process water wash ratios). For example, the wash water could have a sulfuric acid concentration of 50 wt % (e.g., sulfuric acid from S100 could be used in the wash while concentrated sulfuric acid from S200 could be used in an initial digestion of the phosphate materials). However, the wash water can have any suitable sulfuric acid concentration and/or reagents.

Purifying the phosphoric acid and/or remaining solids S460 (e.g., a purification stage) functions to remove byproducts or residual species from the phosphoric acid and/or remaining solids (e.g., washed solids). Examples of purification steps can include: liquid-liquid extraction (e.g., using tributyl phosphate, methyl isobutyl ketone, n-octanol, etc.), nanofiltration, fractional crystallization, and/or other suitable purification steps or processes.

Concentrating the phosphoric acid S480 (e.g., a concentration stage) functions to increase a concentration of the phosphoric acid from about 28% (on a P₂O₅ basis). For instance, the concentration of the phosphoric acid can be increased to between about 40% and 60% (on a P₂O₅ basis). However, the phosphoric acid can be concentrated to higher (or potentially lower) concentrations. The target concentration is typically based on a downstream use of the phosphoric acid (typically for phosphate fertilizer production). However, the target concentration can additionally or alternatively depend on an available energy balance (e.g., available residual heat from other processes for concentrating the phosphoric acid), based on the initial phosphoric acid concentration, and/or based on other suitable criteria. Variants that include concentrating the phosphoric acid can facilitate variations of the method that exclude concentrating the sulfuric acid (e.g., as the processing already exists for concentrating the phosphoric acid rather than the sulfuric acid). The phosphoric acid can be concentrated using a desiccant, using osmosis, via heating (e.g., evaporation of water), and/or in any suitable manner.

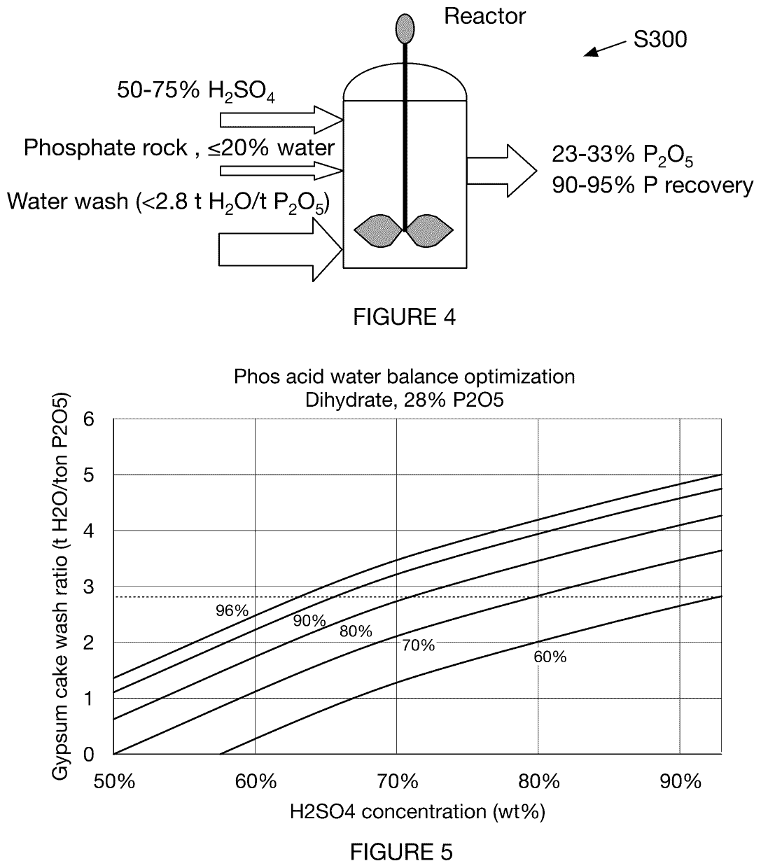

Within S400, a water balance (e.g., total amount of water added, as shown for example in FIG. 4 where an arrow size can be correlated with an amount of water introduced with that material) can be important for achieving the target phosphorous recovery and/or phosphoric acid concentration (e.g., concentration prior to further concentrating steps). Water can be introduced primarily at three points in the process: the sulfuric acid, the phosphate material, and the wash; therefore the balance of water between these steps can be important for achieving the target concentration and/or phosphorous recovery. As shown for example in FIG. 5, the phosphorous recovery and/or phosphoric acid concentration can be achieved, for instance, by using phosphate material that is 96% dry with a sulfuric acid concentration of about 64% (or greater) and a wash ratio of at least 2.8; using phosphate material that is 90% dry with a sulfuric acid concentration of about 66% (or greater) and a wash ratio of at least 2.8; using phosphate material that is 80% dry with a sulfuric acid concentration of about 71% (or greater) and a wash ratio of at least 2.8; and/or in other conditions as shown in the plot. However, other suitable conditions that balance the total water load can also achieve the target phosphorous recovery and/or phosphoric acid concentration.

Optionally producing fertilizer S500 functions to utilize the phosphoric acid (from S400) to generate a phosphate fertilizer (e.g., MAP, DAP, SSP, TSP, NPK, PK, etc.). S500 preferably leverages hydrogen (produced at the cathode in S100) in combination with the phosphoric acid (e.g., thereby indirectly leveraging the sulfuric acid from S100). However, S500 can operate separately or independently from the hydrogen in S100.

S500 can include: receiving ammonia S520, generating ammonium phosphate S550, forming a fertilizer mixture S580 (e.g., mixing MAP or DAP with phosphoric acid and/or muriate of potash or other potassium salt to a suitable concentration of nitrogen, phosphorous, and/or potassium; adding micronutrients such as boron, zinc, molybdenum, iron, manganese, cobalt, etc. to the fertilizer; etc.) and/or any suitable steps.

Receiving ammonia S520 preferably includes producing ammonia S525. For example, ammonia can be produced using the Haber-Bosch process to react nitrogen (e.g., nitrogen concentrated from air, nitrogen from S100, etc.) with hydrogen (e.g., from S100), using dry distillation (e.g., reduction of nitrous acids and nitrites with hydrogen), the Frank-Caro process, Birkeland-Eyde process, from nitrides, and/or in any suitable manner.

Generating ammonium phosphate S550 preferably includes reacting ammonia with phosphoric acid in a suitable ratio to produce an ammonium phosphate fertilizer (as shown for example in FIG. 6). For instance, to generate MAP, the suitable ratio would be 1:1 mole ratio and DAP would be a 2:1 mole ratio of ammonia to phosphoric acid. However, other suitable ratios can be used (e.g., to produce a mixture of MAP and DAP). As a first illustrative example, ammonia (e.g., from S330) can react with phosphoric acid (e.g., from S350) to generate an ammonium phosphate (e.g., (NH₄)₃PO₄, (NH₄)₂HPO₄, (NH₄)H₂PO₄, metal salts of (NH₄)₂PO₄⁻, metal salts of (NH₄)PO₄²⁻, combinations thereof, etc., where metal salts typically but do not necessarily have a biologically beneficial metal cation such as sodium, potassium, magnesium, calcium, aluminium, zinc, nickel, molybdenum, copper, manganese, iron, chromium, cobalt, etc.) which can be used as a phosphate fertilizer. As a second illustrative example, ammonia can react with sulfuric acid (e.g., from S100, S200, etc.) to generate an ammonium sulfate (e.g., (NH₄)₂SO₄, (NH₄)HSO₄, metal salts of (NH₄)SO₄⁻, combinations thereof, etc. where metal salts typically but do not necessarily have a biologically beneficial metal cation such as sodium, potassium, magnesium, calcium, aluminium, zinc, nickel, molybdenum, copper, manganese, iron, chromium, cobalt, etc.) which can be used as a sulfate fertilizer.

Extracting and/or separating metals from ore S600 can function to obtain base metal (and/or metal salts) from ore and/or can separate two or more metals from an ore. Examples of base metals (and/or metals that can be present in metal salts) include but are not limited to copper, zinc, lithium, nickel, uranium, cobalt, silver, gold, iron, and/or other alkali metals, alkaline earth metals, transition metals, rare earth metals, actinides, and/or semimetals. Examples of ores that can be processed include (but are not limited to): nickel laterite, spodumene, lepidolite, petalite, amblygonite, eucryptite, chalcopyrite, chalcocite, covellite, bornite, digenite, malachite, azurite, cuprite, chrysocolla, dioptase, cobaltite, smaltite, erythrite, glaucodot, linnaeite, sphalerite, calamine, marmatite, uraninite, carnotite, tyuyamunite, torbernite, and autunite. Typically, the ores are oxides and/or sulfides. However, other ores (e.g., silicates, carbonates, borates, aluminates, titanates, etc.) can be processed.

Processing the ore can include leaching and/or digesting the ore (e.g., using sulfuric acid, typically, concentrated sulfuric acid from S200, but potentially sulfuric acid as produced via the electrolyzer in S100), washing the ore (e.g., to remove organic constituents such as using sulfuric acid from S100, S200, etc.), reducing metal species (e.g., into base metal such as using hydrogen from S100), and/or other suitable processes can be performed.

In one illustrative example, ammonia can react with metal ions to form metal ammonia complexes. These metal ammonia complexes can be used to separate two or more metals from one another (e.g., to separate nickel from iron or other metal ions present in nickel laterite).

All or portions of the method can be performed by one or more components of the system, using a computing system (e.g., operable to run or operate a phosphoric acid production facility), by a user, and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, and/or FPGA/ASIC. However, the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. A method comprising:
receiving sulfur dioxide;
electrochemically generating hydrogen and sulfuric acid from water and a first quantity of sulfur dioxide from the received sulfur dioxide, wherein a concentration of the sulfuric acid is at most 50 wt % sulfuric acid; and
concentrating the sulfuric acid by:
oxidizing a second quantity of sulfur dioxide from the received sulfur dioxide to form sulfur trioxide; and
dissolving the sulfur trioxide in the sulfuric acid, wherein a concentration of the concentrated sulfuric acid is at least 70 wt % sulfuric acid.

2. The method of claim 1, further comprising:
forming ammonia using the hydrogen;
forming phosphoric acid from phosphate ore using the concentrated sulfuric acid, wherein a hydration of the phosphate ore is at most 20 wt %; and
forming at least one of monoammonium phosphate, diammonium phosphate, or triammonium phosphate from the ammonia and the phosphoric acid.

3. The method of claim 2, wherein the phosphate ore comprises at least one of monetite, brushite, whitlockite, hydroxyapatite, apatite, hilgenstockite, merrillite, changesite, fluoroapatite, chloroapatite, francolite, octacalcium phosphate, monocalcium phosphate, tricalcium phosphate, tetracalcium phosphate, or combinations thereof.

4. The method of claim 1 further comprising leaching a metal from an ore using the concentrated sulfuric acid.

5. The method of claim 4, further comprising reducing the metal using the hydrogen.

6. The method of claim 4, wherein the ore comprises at least one of nickel laterite, spodumene, lepidolite, petalite, amblygonite, eucryptite, chalcopyrite, chalcocite, covellite, bornite, digenite, malachite, azurite, cuprite, chrysocolla, dioptase, cobaltite, smaltite, erythrite, glaucodot, linnaeite, sphalerite, calamine, marmatite, uraninite, carnotite, tyuyamunite, torbernite, and autunite.

7. The method of claim 1, further comprising roasting a sulfur precursor to form the sulfur dioxide.

8. The method of claim 7, wherein roasting the sulfur precursor to form the sulfur dioxide comprises:
separating air into an oxygen rich gas and a nitrogen rich gas;
roasting the sulfur precursor with the oxygen rich gas; and
removing water from at least one of the at most 50 wt % sulfuric acid or the at least 70 wt % sulfuric acid by passing the nitrogen rich gas over or through the at least one of the at most 50 wt % sulfuric acid or the at least 70 wt % sulfuric acid thereby increasing a concentration of the sulfuric acid.

9. The method of claim 1, further comprising:
separating residual sulfur dioxide from the at most 50 wt % sulfuric acid; and
recycling the residual sulfur dioxide with the first quantity of sulfur dioxide or the second quantity of sulfur dioxide.

10. The method of claim 1, wherein none of the sulfuric acid is recycled to sulfur dioxide and reintroduced into the electrolyzer.

11. A method comprising:
receiving sulfur dioxide;
electrochemically generating hydrogen and a first quantity of sulfuric acid from water and a first quantity of sulfur dioxide from the received sulfur dioxide, wherein a concentration of the first quantity of sulfuric acid is at most 50 wt % sulfuric acid;
generating a second quantity of sulfuric acid by:
oxidizing a second quantity of sulfur dioxide from the received sulfur dioxide to form sulfur trioxide;
forming oleum using the sulfur trioxide; and
diluting the oleum with water to form the second quantity of sulfuric acid, wherein a concentration of the second quantity of sulfuric acid is greater than 90 wt %; and
mixing the first quantity of sulfuric acid and the second quantity of sulfuric acid to form a sulfuric acid solution with a concentration between 65 and 80 wt %.

12. The method of claim 11, further comprising:
forming ammonia using the hydrogen;
forming phosphoric acid from phosphate ore using the sulfuric acid solution, wherein the phosphate ore is at least 70% solid; and
forming at least one of monoammonium phosphate, diammonium phosphate, or triammonium phosphate from the ammonia and the phosphoric acid.

13. The method of claim 12, wherein the phosphate ore comprises at least one of monetite, brushite, whitlockite, hydroxyapatite, apatite, hilgenstockite, merrillite, changesite, fluoroapatite, chloroapatite, francolite, octacalcium phosphate, monocalcium phosphate, tricalcium phosphate, tetracalcium phosphate, or combinations thereof.

14. The method of claim 11 further comprising leaching a metal from an ore using the sulfuric acid solution.

15. The method of claim 14, further comprising reducing the metal using the hydrogen.

16. The method of claim 14, wherein the ore comprises at least one of nickel laterite, spodumene, lepidolite, petalite, amblygonite, eucryptite, chalcopyrite, chalcocite, covellite, bornite, digenite, malachite, azurite, cuprite, chrysocolla, dioptase, cobaltite, smaltite, erythrite, glaucodot, linnaeite, sphalerite, calamine, marmatite, uraninite, carnotite, tyuyamunite, torbernite, and autunite.

17. The method of claim 11, further comprising roasting a sulfur precursor to form the sulfur dioxide.

18. The method of claim 17, wherein roasting the sulfur precursor to form the sulfur dioxide comprises:
separating air into an oxygen rich gas and a nitrogen rich gas;
roasting the sulfur precursor with the oxygen rich gas; and
removing water from at least one of the first quantity of sulfuric acid or the second quantity of sulfuric acid by passing the nitrogen rich gas over or through the at least one of the first quantity of sulfuric acid or the second quantity of sulfuric acid thereby increasing a concentration of the sulfuric acid.

19. The method of claim 11, further comprising:
separating residual sulfur dioxide from the first quantity of sulfuric acid; and
recycling the residual sulfur dioxide with the first quantity of sulfur dioxide or the second quantity of sulfur dioxide.

20. The method of claim 11, wherein none of the sulfuric acid is recycled to sulfur dioxide and reintroduced into an electrolyzer used to electrochemically generating the hydrogen and the first quantity of sulfuric acid.
